(19) United States
(12) Patent Application Publication
(10) Pub. No.: US 2007/0269162 A1
(43) Pub. Date: Nov. 22, 2007

(54) Optical fiber cable to inject or extract light

(75) Inventor: Kenneth R. Schroll, Chatham, NJ (US)

Correspondence Address: STEPTOE & JOHNSON LLP, 1330 CONNECTICUT AVENUE, N.W., WASHINGTON, DC, 20036, US

(73) Assignee: General Dynamics Advanced Information Systems, Ypsilanti, MI (US)

(21) Appl. No.: 11/435,724

(22) Filed: May 18, 2006

(51) Int. Cl. G02B 6/26

(52) U.S. Cl. 385/32

(57) ABSTRACT

A system and method are provided for setting a light loss through an optical fiber. A portion of the optical fiber is clamped. An unclamped portion of the optical fiber is bent. A bent region of the optical fiber is heated. The amount of light that is at least one of leaving the heated bent region or passing through the optical fiber downstream from the heated bent region is monitored. The heating is discontinued when the amount of light reaches the desired level. The resulting optical fiber has particular application in an optical coupler.

### BACKGROUND OF THE INVENTION

1. Field of the Invention

The present invention relates to the field of fiber optics. More particularly, the present invention is directed to bending one or more optical fibers to extract light from or inject light into a fiber optical cable.

2. Discussion of Background Information

Commercially available single mode optical fiber couplers typically are made by twisting two uncoated optical fibers together, heating the twisted region, and pulling on the fiber ends to reduce the diameter of the heated and softened region. When the fiber diameters are reduced sufficiently, the fibers' core modes overlap to produce the desired optical coupling. In principle, this method could be applied to couple to an active fiber without interrupting data transmission through the active fiber, but the procedure would be very risky and would require complex, specialized equipment and precise control over the drawing process.

Another method for coupling to an active fiber in a non-interrupting manner involves forming a macrobend, typically a constant-radius curve, in a fiber and injecting light through the bend into the core of the fiber. The light injector can consist of a cleaved single mode fiber plus a suitable lens. Injection efficiency (the fraction of the light leaving the injector which actually couples into the core mode of the subject fiber) using the macrobend approach tends to be very low due to inherently poor coupling. In addition, the macrobend techniques usually are applied only to conventional polymer-coated fiber because of the reliability concerns associated with bare fiber. When injecting through the polymer coating, aligning the injector with the single mode core of the bent fiber is extremely difficult, and the resulting coupling is inefficient.

The basic macrobend technique also can be used to extract light from an optical fiber. For example, some commercial “fiber identifiers” used by fiber system installers utilize the macrobend technique for extracting light to identify active fibers and light propagation direction. Some commercially available macrobend-type couplers are available for use in connection with multiple-fiber ribbons. However, the macrobend approach typically is not used for permanent couplers because of inherent inefficiencies, plus reliability concerns related to the fiber bending stresses. Bend-type couplers tend to subject the fiber to high bending stresses which are detrimental to the reliability of the fiber because of a phenomenon known as static fatigue. Static fatigue can cause a fiber in bending or tension to fail over time due to the propagation of cracks. The higher the initial stress a fiber is subjected to, the shorter its life is likely to be. Heating and subsequently cooling the fiber to form a permanent bend can reduce the overall stress on the fiber.

Applicant's U.S. Pat. No. 6,665,469 discloses a fully elastic “transition-bend” coupler. A depressor produces a “pure” cantilever shape that induces a sufficiently severe bend in the fiber such that light will exit the fiber through its side. The depressor is a movable, high-precision mechanical element that can be adjusted to create a severe enough bend to provide the desired amount of escaping light. Due to the elastic nature of the fiber, the bend induced by the depressor is temporary, in that the fiber tends to return to an unbent state if the depressor disengages the fiber. While a workable device can be constructed based on this principle, it is found in practice that an elastic bend sufficient to extract a useful amount of light produces undesirably high bending stresses in the fiber at the clamp edge.

### SUMMARY

According to an embodiment of the invention, a method for setting a light loss through an optical fiber is provided. A portion of the optical fiber is clamped. An unclamped portion of the optical fiber is bent. A bent region of the optical fiber is heated. The amount of light that is at least one of leaving the heated bent region or passing through the optical fiber downstream from the heated bent region is monitored. The heating is discontinued when the amount of light reaches the desired level.

The above embodiment may have various non-limiting optional features. Preferably no light is lost from the optical fiber prior to the heating. Prior to the clamping, an outer coating of the optical fiber is removed adjacent the portion and adjacent another portion of the optical fiber that corresponds to the bent region. The monitoring may include monitoring the amount of light that is leaving the heated bent region, and the discontinuing may include that the application of heat is responsive to the amount of light increasing to the desired level. The monitoring may include monitoring the amount of light that is passing through the optical fiber downstream from the heated bent region, and the discontinuing may include that the application of heat is responsive to the amount of light decreasing to the desired level. The heating may include heating a length of the optical fiber that is less than or substantially equal to a diameter of the optical fiber. The optical fiber may include a first optical fiber, where the portion of the first optical fiber is co-axially aligned with a second optical fiber. The heated bend region may be optically connected with the second optical fiber, such as by applying a medium with an index of refraction which is substantially equal to an index of refraction of a cladding of the first optical fiber.

According to another embodiment of the invention, a method for setting a light loss through a set of optical fibers is provided. A portion of the set of optical fibers is clamped. An unclamped portion of the set of optical fibers is bent. A bent region of the set of optical fibers is heated. A change in a light flow responsive to the heating is monitored. The heating is discontinued when the change in the light flow reaches the desired level.

The above embodiment may have various optional features. The heating may include individually heating each fiber of the set of optical fibers, the monitoring may include monitoring a respective one of the set of optical fibers that is subject to the heating and the discontinuing may include discontinuing the heating when the change in the light flow associated with the respective one of the set of optical fibers reaches the desired level, and the heating, monitoring and discontinuing steps repeat for each fiber of the set of optical fibers. Preferably, no light is lost from the set of optical fibers prior to the heating. Prior to the clamping, an outer coating of the set of optical fibers adjacent the portion and adjacent another portion of the optical fiber that corresponds to the bent region may be removed. The heating may include heating a length of the set of optical fibers that is less than or substantially equal to a diameter of an individual optical fiber of the set. A second set of optical fibers may be coaxially aligned with the portion of the first set of optical fibers. The heated bent region of the first set of optical fibers may be optically connected with the second set of optical fibers, such as by applying a medium with an index of refraction which is substantially equal to an index of refraction of a cladding of the first set of optical fibers.

According to yet another embodiment of the invention, an apparatus for exchanging light energy between a first optical fiber and a second optical fiber is provided. The first optical fiber has a first portion, a second portion, and a permanently bent portion between the first and second portions. A clamp is configured to hold the first portion of the first optical fiber in a predetermined orientation along an axis. A member is configured to support and direct the second portion of the optical fiber in a predetermined orientation at a non-zero angle to the axis. The permanently bent portion is located between the clamp and the member. Light energy from the second optical fiber is focused at the permanently bent portion, and light energy from the permanently bent portion is focused at the second optical fiber.

The above embodiment may have various non-limiting optional features. An outer polymer coating of the first, second, and permanently bent portions of the first optical fiber may be removed to expose an underlying cladding of the first optical fiber to an external medium. The first portion of the first optical fiber may be coaxially aligned with the second optical fiber.

According to still yet another embodiment of the invention, a system for coupling first and second optical fibers is provided. A clamp is configured to hold a first portion of the first optical fiber. A support member is configured to hold the second optical fiber in coaxial alignment with the first portion of the first optical fiber. A depressor is configured to bend the first optical fiber. A heat source is configured to heat a second portion of the first optical fiber between the clamp and the depressor. A detector is configured to, during at least operation of the heat source, monitor a change in light flow through at least one of the first optical fiber and the second optical fiber, and to control the heat source in response thereto.

The above embodiment may have various non-limiting optional features. The clamp may include a portion of the support member. The support member and the depressor may hold the second optical fiber. The heat source may be a laser. The heat source may be configured to heat a length of said second portion that is less than or substantially equal to a diameter of said second portion. The length of said second portion may be adjacent to and offset from said clamp.

Other exemplary embodiments and advantages of the present invention may be ascertained by reviewing the present disclosure and the accompanying drawings.

### BRIEF DESCRIPTION OF THE DRAWINGS

The present invention is further described in the detailed description which follows, in reference to the noted plurality of drawings by way of non-limiting examples of certain embodiments of the present invention, in which like numerals represent like elements throughout the several views of the drawings, and wherein:

FIG. 1 illustrates a side-view of a clamped elastic optical traffic fiber being deflected by a depressor to bend a fiber;

FIG. 2 illustrates a side-view of a clamped deflected elastic optical traffic fiber being heated to create a hinge;

FIG. 3 illustrates a side-view of pickup/injection fiber aligned with the clamped portion of the optical traffic fiber;

FIG. 4 illustrates a side-view of a substrate that aligns a lensed pickup/injection fiber with the clamped portion of the optical traffic fiber; and

FIG. 5 illustrates a perspective view of a substrate supporting a multi-fiber application for use as an optical coupler.

### DETAILED DESCRIPTION OF EXEMPLARY EMBODIMENTS

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description taken with the drawings making apparent to those skilled in the art how the several forms of the present invention may be embodied in practice.

Examples of the present invention provide an adjustable fiber optic coupler that allows efficient light injection into or extraction from one or more active fibers to increase the capacity of a fiber optic system without disrupting existing traffic through the fiber. Single mode pickup/injector fibers simultaneously insert/receive optical signals through the side of single mode cores of corresponding traffic fibers. This makes it possible, for example, for the insertion of additional wavelengths into multiple fibers (e.g., fiber ribbon) carrying WDM (wavelength division multiplexed) signals, without disrupting the existing traffic. The transmission capacity of active fibers or a network can be upgraded without shutting the underlying system down, and without requiring alternate or “protect” fibers to temporarily carry the traffic over such a network.

The embodiments herein take advantage of what is commonly referred to as the “transition effect.” The transition effect occurs in an optical fiber at a location of curvature discontinuity, such as the point of transition from substantially straight fiber to curved fiber. The transition loss, which occurs for light propagating in either direction, is defined as the amount of light extracted from the fiber (the “loss”) at the curvature discontinuity, or transition point. The controlled application of heat to the fiber is used to create a curvature discontinuity for the desired amount of light loss.

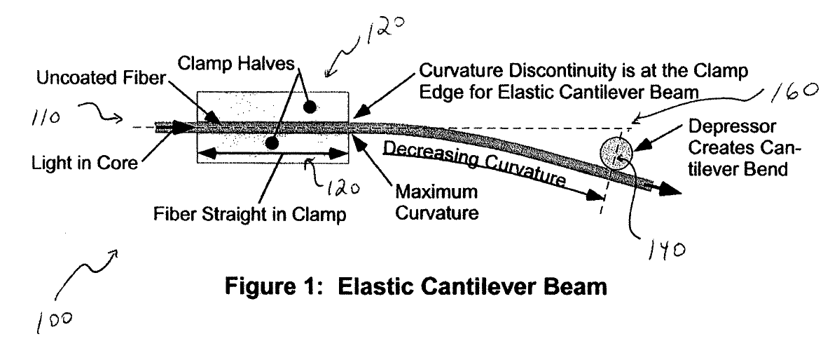

Referring now to FIG. 1, a configuration 100 includes an optical traffic fiber 110 from which light is to be ejected. Traffic fiber 110 is preferably elastic, in that it will bend in response to applied force but will tend to return to its original shape when the bending force is removed. The outer polymer coating around the cladding of traffic fiber 110 has been removed (by process not shown) along approximately 1-3 cm of the length of traffic fiber 110. Opposing halves of a clamp 120 hold rigidly a portion of the exposed traffic fiber 110 in a straight line with substantially zero curvature, to thereby define a central axis 160. Downstream from clamp 120, a depressor 140 deflects the path of traffic fiber 110 off axis 160, resulting in a cantilevered configuration for fiber 110.

A characteristic of traffic fiber 110 is that the maximum curvature (i.e., minimum radius) occurs at the downstream edge of clamp 120. Specifically, within clamp 120, traffic fiber 110 is straight and has substantially zero curvature. The curvature of traffic fiber 110 is at its maximum value immediately outside clamp 120, and diminishes to substantially zero curvature at depressor 140 as traffic fiber 110 returns to a straight path. The resulting curvature is small, preferably less more than 10 millimeters in radius, such that it does not induce any light loss in traffic fiber 110. Such a bend is mild enough that the maximum applied stress will not effect the useful fiber lifetime (i.e., years or tens of years).

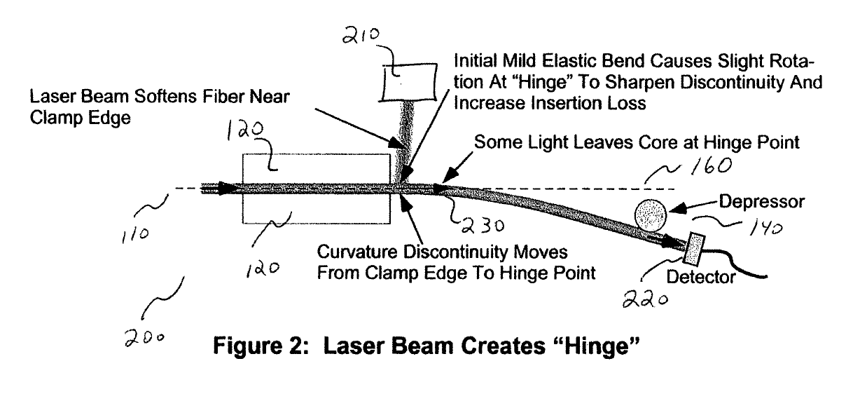

Referring now also to FIG. 2, a localized heat source 210 applies heat to traffic fiber 110 at a point between clamp 120 and deflector 140. The exact focus point of heat source 210 is preferably closer to clamp 120 (with a slight offset to prevent clamp 120 from acting as a significant heat sink). Heat source 210 is preferably a CO₂ laser emitter of 5-10 Watts with a wavelength that will be absorbed by the fiber optics. Heat source 210 focuses its laser beam over a length of traffic fiber 110 that is approximately less than or equal to the diameter of traffic fiber 110.

The applied heat softens traffic fiber 110 at the heated area, thereby creating a flexible “hinge” 230 about which the adjacent upstream and downstream portions of traffic fiber 110 can rotate. As heat source 210 heats traffic fiber 110, fiber 110 continues to rotate about hinge 230. Hinge 230 creates a sharper discontinuity in traffic fiber 110 through which light escapes in greater quantities compared to its pre-heated state, which light loss increases as the radius of curvature at hinge 230 decreases during the application of heat. When heat source 210 stops heating the area (i.e., when heat source 210 is turned OFF or reduced in power), the soften region hardens and the amount of light loss is set. Traffic fiber 110 is now permanently deformed, in that it will tend to remain in the new shape absent subsequent application of heat or destructive forces.

The discontinuity strength, and thus the amount of escaping light, can be precisely controlled by monitoring the changes in the amount of light either exiting traffic fiber 110 or continuing to flow through traffic fiber 110 during the heating process. The embodiment of FIG. 2 shows a detector 220 in the downstream path of traffic fiber 110. Detector 220 measures the amount of light passing through traffic fiber 110 downstream from hinge 230. Detector 220 and associated feedback circuitry (not shown) monitor the decrease in light in traffic fiber 110 during the heating process, and continues to apply heat from heat source 210 until the amount of detected light decreases to a desired level.

The inducement of the sharper discontinuity does not induce higher stress on traffic fiber 110, but rather reduces the overall stress. Prior to heating, stress from the curvature discontinuity in traffic fiber 110 is at a maximum at the edge of clamp 120. As traffic fiber 110 softens, the softened glass cannot support the pre-existing bending moment associated with the elastic bend, and the curvature discontinuity “migrates” from the edge of clamp 120 edge to hinge 230. As a result, the length of curved traffic fiber 110 between clamp 120 and hinge 230 tends to straighten out, thereby alleviating the associated stress. Hinge 230 is preferably slightly offset downstream from clamp 120 by approximately 1-4 times the diameter of fiber 110 to prevent clamp 120 from acting as a heat sink during heating.

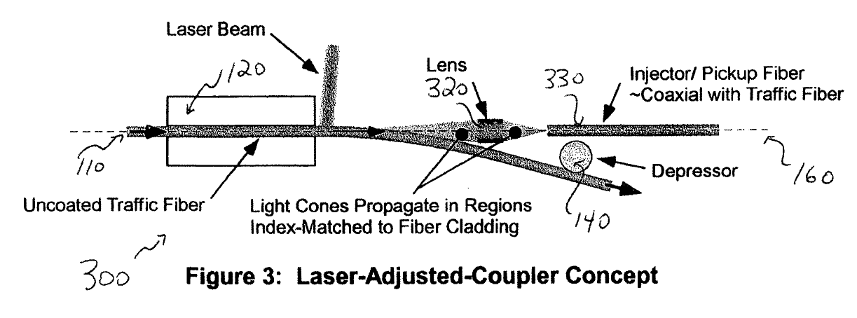

Referring now to FIG. 3, an embodiment 300 is shown in which the laser-heated hinged traffic fiber 110 is used in a fiber coupler. The light exits near the edge of clamp 120 along a line substantially coaxial with axis 160. Since the light exits traffic fiber 110 within a tight cone, the emerging light can be captured with relatively high efficiency by a pre-positioned pickup fiber 330. A lens 320 preferably collects and focuses the light to the desired location. Injection efficiency is at its highest when the core of pickup fiber 330 aligns with axis 160.

The arrangement in FIG. 3 is symmetrical in the sense that it can provide both “drop” (extraction) and “add” (injection) functions, depending on the direction of propagation. In the injection mode, pickup fiber 330 acts as an injector fiber that can be pre-positioned to be coaxial with traffic fiber 110 in clamp 120, and the discontinuity at the edge of clamp 120 is effectively the focal point for injection.

For proper functioning of the coupler, the light propagation region external to the fibers 110 and 330 (and lens 320) should be index-matched to the cladding of fiber 110. In the extraction mode, the light will likely not exit the bend in fiber 110 if the refractive index of the surrounding medium is much below that of the cladding, but will be retained by total internal reflection. Preferably, an index matching medium is applied in the space where the light beam propagates between traffic fiber 110 and pickup/injector fiber 330 through lens 320. The index matching medium, preferably a non-migrating optical gel, a hybrid sol-gel, or similar coupling medium as would be known to one skilled in the art, has an index of refraction substantially the same as the index of the cladding of traffic fiber 110, which typically is fused silica. An index match between traffic fiber 110 cladding and the index matching medium does not tend to refract the injected or extracted light beam at the curved surface of the traffic fiber cladding, and reflection at the lens face is minimized. Index matching material also protects traffic fiber 110 to at least partially compensate for the protection lost by the removal of the outer polymer coating.

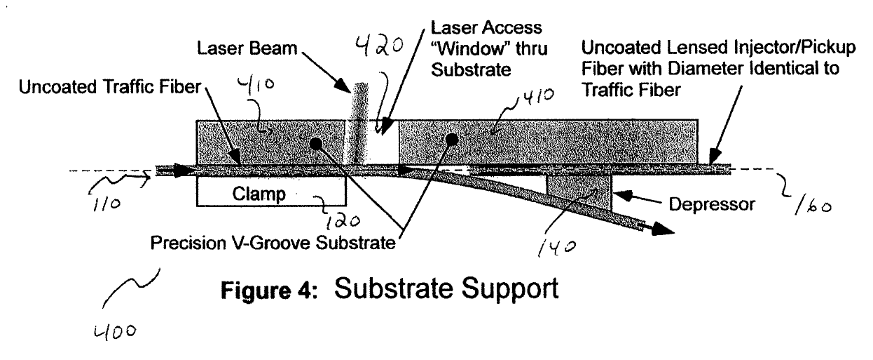

Referring now to FIG. 4, an embodiment 400 includes a silicon v-groove substrate 410 that aligns the optical components. Substrate 410 serves as one half of clamp 120, and has an opening 420 through which heat source 210 accesses traffic fiber 110. The two halves of clamp 120 (or substrate 410 and clamp 120) can be adhesively or mechanically held together. A lensed single mode pickup/injector fiber 430 is preferably a GRIN lens fused to a length of coreless fiber that is fused to the end of the pickup/injector fiber 330. Lensed fibers are available commercially or can be fabricated in the laboratory.

Ideally, the parabolic index profile of the lens extends all the way to the outside cylindrical surface of the lens to maximize its light-gathering capability. The diameter of all sections of the lensed fiber 430 is preferably identical to that of the clamped fiber, and the lensed fiber 430 similarly has its outer polymer coating removed in the region of the coupler. Substrate 410 provides for precise alignment of the components along axis 160 such that the lensed fiber 430 is substantially coaxial with the clamped fiber 110. The discontinuity at hinge 230 also preferably lies on axis 160.

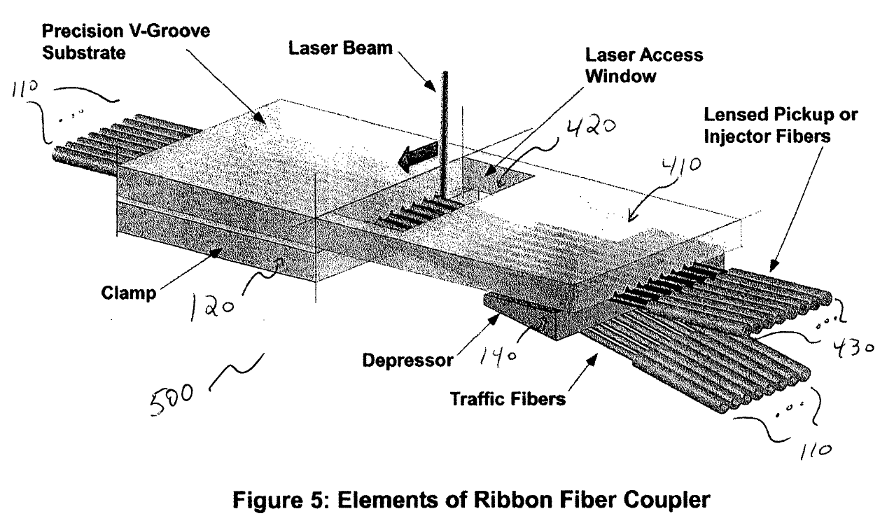

Referring now to FIG. 5, a multi-fiber coupler 500 shows the configuration of FIG. 4 applied to multiple fibers or ribbon fibers 110. The separation of the outer polymer coating of fibers 110 in the vicinity of coupler 500 is best seen downstream from substrate 410. The v-shaped parallel precision grooves of substrate 410 are typically on 250-micron centers. The outside diameter of the coating on communications fibers is nominally 250 microns, twice the diameter of the glass fiber itself. In the multi-fiber coupler of FIG. 5, substrate 410 provides the precision alignments for each of the individual couplers, one per groove. Window 420 is wide enough to span all the traffic fibers 110. The lensed injector/pickup fibers 430 of all the couplers are pre-mounted in the v-grooves, and a common depressor 140 applies the same initial elastic cantilever bend to all the traffic fibers 110. The laser beam from heat source 210 (not shown in FIG. 5) would be applied sequentially to each of the traffic fibers 110 to adjust and set the insertion loss to the desired value. As shown in FIG. 2, a photo detector or a detector array could provide feedback to control the adjustment of each coupler. Window 420 would also provide access for application of an index-matching medium as discussed above.

The width of multi-fiber coupler 500 could be as small as 250 microns times the number of couplers, plus a few millimeters. The length could be as short as 1-2 cm, and the thickness on the order of 0.5 cm. It is estimated that automated assembly and adjustment of 12-fibers would take only minutes, once the traffic fibers 110 were positioned in the v-grooves.

Various modifications may be made to the above disclosed embodiments within the skill of the art. By way of non-limiting example, traffic fiber 110 need not have the outer polymer coating removed, or it may be only partially removed. If removed, the exposed cladding can be of any desired length.

Clamp 120 is preferably approximately ten (10) times as thick as the diameter of the core of traffic fiber 110, although any thickness may be used. Clamp 120 can hold traffic fiber 110 in a non-straight line.

FIGS. 1-5 show depressor 140 directing the traffic fiber(s) 110 in a downward direction. However, the invention is not so limited, as depressor 140 can divert fiber(s) 110 in any direction off of axis 160. Depressor 140 is shown in various figures as having a cylindrical or wedge shaped cross section, but any desired shape may be used. V-shaped grooves can be provided in depressor 140 to support and guide fiber(s) 110. Depressor 140 can be made of an integral piece or multiple pieces, including a top and bottom component that supports fiber(s) 110 on both sides. It can be moveable or fixed; if moveable, a stopper can be provided to prevent applying too much stress on fiber(s) 110.

In the preferred embodiment, heat source 210 simply turns ON and OFF. Heat source 210 could also be adjustable to gradually or incrementally increase and/or decrease the application of heat. Heat source 210 may be a single unit or multiple units, e.g., one laser that heats fiber(s) 110 individually or collectively, or multiple lasers that each heat one or more fiber(s) 100. Although heat source 210 is preferably a CO₂ laser, any type of controllable heat source (laser and non-laser) may be used.

The lens used in conjunction with the pickup/injector fibers 330 and 430 preferably has the same diameter as the pickup injector fibers. However, a larger diameter lens can also be used. This may increase efficiency of the light coupling for both extraction and injection, but may also negate some of the “automatic” alignment provided by the v-groove substrate and leads to a larger and more complex device. In any of these arrangements, the propagation regions external to the fibers and lens should be index-matched to the fiber cladding.

It is noted that the foregoing examples have been provided merely for the purpose of explanation and are in no way to be construed as limiting of the present invention. While the present invention has been described with reference to certain embodiments, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular means, materials and embodiments, the present invention is not intended to be limited to the particulars disclosed herein; rather, the present invention extends to all functionally equivalent structures, methods and uses, such as are within the scope of the appended claims.

What is claimed is:

1. A method for setting a light loss through an optical fiber, comprising:
clamping a portion of the optical fiber;
bending an unclamped portion of the optical fiber;
heating a bent region of the optical fiber;
monitoring the amount of light that is at least one of leaving the heated bent region or passing through the optical fiber downstream from the heated bent region; and
discontinuing said heating when the amount of light reaches the desired level.

2. The method of claim 1, wherein no light is lost from the optical fiber prior to said heating.

3. The method of claim 1, further comprising removing, prior to said clamping, an outer coating of the optical fiber adjacent said portion.

4. The method of claim 1, further comprising, prior to said heating, removing an outer coating of the optical fiber adjacent another portion of the optical fiber that corresponds to the bent region.

5. The method of claim 1, wherein said monitoring comprises monitoring the amount of light that is leaving the heated bent region, and said discontinuing said heating is responsive to the amount of light increasing to the desired level.

6. The method of claim 1, wherein said monitoring comprises monitoring the amount of light that is passing through the optical fiber downstream from the heated bent region, and said discontinuing said heating is responsive to the amount of light decreasing to the desired level.

7. The method of claim 1, wherein said heating comprises heating a length of the optical fiber that is less than or substantially equal to a diameter of the optical fiber.

8. The method of claim 1, wherein the optical fiber comprises a first optical fiber, said method further comprising co-axially aligning a second optical fiber with the portion of the first optical fiber.

9. The method of claim 1, wherein said optical fiber comprises a first optical fiber, said method further comprising optically connecting the heated bent region of the first optical fiber with the second optical fiber.

10. The method of claim 9, wherein said optically connecting comprises applying a medium with an index of refraction which is substantially equal to an index of refraction of a cladding of the first optical fiber.

11. A method for setting a light loss through a set of optical fibers, comprising:
clamping a portion of the set of optical fibers;
bending an unclamped portion of the set of optical fibers;
heating a bent region of the set of optical fibers;
monitoring a change in a light flow responsive to said heating; and
discontinuing said heating when the change in the light flow reaches the desired level.

12. The method of claim 1, wherein:
said heating comprises individually heating each fiber of the set of optical fibers;
said monitoring comprises monitoring a respective one of the set of optical fibers that is subject to said heating; and
said discontinuing comprises discontinuing said heating when the change in the light flow associated with the respective one of the set of optical fibers reaches the desired level;
wherein said heating, monitoring and discontinuing steps repeat for each fiber of said set of optical fibers.

13. The method of claim 11, wherein no light is lost from the set of optical fibers prior to said heating.

14. The method of claim 11, further comprising removing, prior to said clamping, an outer coating of the set of optical fibers adjacent said portion.

15. The method of claim 11, further comprising, prior to said heating, removing an outer coating of the optical fiber adjacent another portion of the optical fiber that corresponds to the bent region.

16. The method of claim 11, wherein said heating comprises heating a length of the set of optical fibers that is less than or substantially equal to a diameter of an individual optical fiber of the set.

17. The method of claim 11, further comprising coaxially aligning a second set optical fibers with the portion of the first set of optical fibers.

18. The method of claim 11, further comprising optically connecting the heated bent region of the first set of optical fibers with the second set of optical fibers.

19. The method of claim 18, wherein said optically connecting comprises applying a medium with an index of refraction which is substantially equal to an index of refraction of a cladding of the first set of optical fibers.

20. An apparatus for exchanging light energy between a first optical fiber and a second optical fiber, the apparatus comprising:
said first optical fiber having first portion, a second portion, and a permanently bent portion between said first and second portions;
a clamp configured to hold said first portion of said first optical fiber in a predetermined orientation along an axis;
a member configured to support and direct said second portion of said optical fiber in a predetermined orientation at a non-zero angle to said axis; and
said permanently bent portion being located between said clamp and said member;
wherein light energy from said second optical fiber is focused at said permanently bent portion, and light energy from said permanently bent portion is focused at said second optical fiber.

21. The apparatus of claim 20, wherein an outer polymer coating of said first, second, and permanently bent portions of said first optical fiber has been removed to expose an underlying cladding of the first optical fiber to an external medium.

22. The apparatus of claim 20, wherein said first portion of said first optical fiber is coaxially aligned with said second optical fiber.

23. A system for coupling first and second optical fibers, comprising:
a clamp configured to hold a first portion of the first optical fiber;
a support member configured to hold the second optical fiber in coaxial alignment with the first portion of the first optical fiber;
a depressor configured to bend the first optical fiber;
a heat source configured to heat a second portion of the first optical fiber between said clamp and said depressor; and
a detector configured to, during at least operation of said heat source, monitor a change in light flow through at least one of the first optical fiber and the second optical fiber, and to control said heat source in response thereto.

24. The system of claim 23, wherein said clamp includes a portion of said support member.

25. The system of claim 23, wherein said support member and said depressor hold the second optical fiber.

26. The system of claim 23, wherein said heat source is a laser.

27. The system of claim 23, wherein said heat source is configured to heat a length of said second portion that is less than or substantially equal to a diameter of said second portion.

28. The system of claim 27, wherein said length of said second portion is adjacent to and offset from said clamp.
